(19) United States
(12) Patent Application Publication
(10) Pub. No.: US 2020/0093082 A1
(43) Pub. Date: Mar. 26, 2020

(54) Nutrient Caps for Vertical Growing System

(71) Applicant: Bellwether Innovations, LLC, Spring, TX (US)

(72) Inventors: Sandra Lee Mathieu, Spring, TX (US); Cynthia Lynn Mathieu, Spring, TX (US)

(21) Appl. No.: 16/579,594

(22) Filed: Sep. 23, 2019

Related U.S. Application Data
(60) Provisional application No. 62/734,446, filed on Sep. 21, 2018.

(51) Int. Cl. A01G 31/06; A01G 7/04

(52) U.S. Cl. CPC A01G 31/06; A01G 2031/006; A01G 7/045

(57) ABSTRACT

A vertical growing system includes a nutrient cap and a base that removably support a grow tower formed from a pipe with a number of grow pockets adhered to the pipe. The roots of plants in the grow pockets extend inside the pipe, where they are hydrated by irrigation fluid flowing from the cap, through the pipe, through the base, and into a reservoir or collection system. A user can easily install and remove the pipe without having to remove the cap or base. The cap contains nutrient media, such as charged biochar and coarse sand, that supplies nutrients to the irrigation fluid as it percolates through the cap. A 4-tower embodiment included four grow towers above a reservoir. A submersible pump supplies irritation fluid from the reservoir to the nutrient caps. A central light rotates to illuminate the plants in light-dark cycles.

### REFERENCE TO RELATED APPLICATION

This application claims priority to U.S. Provisional Patent Application Ser. No. No. 62734446, which is incorporated by reference.

### TECHNICAL FIELD

The present invention is directed to aquaponic growing systems and, more specifically, to filter systems referred to as “Nutrient Caps” capable of incorporating biochar and other types of filters into a vertical growing system.

### BACKGROUND

U.S. patent application Ser. No. 14/943,329 (U.S. Pub. No. 20160135398) describes a vertical growing system referred to as “grow pockets” that is suitable for use in a aquaponics plant growing system in which fish waste from live fish living in an aquatic reservoir is supplied as a nutrient to plants growing in an aquaponic plant growing system. While the Grow Pocket towers are an effective way to utilize the aquaponic nutrition in a plant growing system, purely conventional aquaponics systems may not take full advantage of the potential of the aquaponic cycle. There is, therefore, a need for a more effective techniques for integrating aquatic nutrition into the grow pocket and other plant growing systems.

### SUMMARY

The invention solves the problems described above through a vertical growing system with nutrient caps. An illustrative embodiment includes a nutrient cap and a base that removably support a grow tower formed from a pipe (e.g., 4″ PVC pipe) with a number of grow pockets adhered to the pipe. The roots of plants in the grow pockets extend inside the pipe, where they are hydrated by irrigation fluid flowing from the cap, through the pipe, through the base, and into a reservoir or collection system. A user can easily install and remove the pipe without having to remove the cap or base. The nutrient cap contains nutrient media, such as charged biochar and coarse sand, that supplies nutrients to the irrigation fluid as it percolates through the cap.

In a 4-tower embodiment, four grow towers are each supported by a nutrient cap and base above a reservoir. A submersible pump supplies irritation fluid from the reservoir to the nutrient caps. A central light rotates to illuminate the plants in light-dark cycles. In a drum type embodiment, a larger drum carries a larger number of grow pockets above a larger reservoir. The drum with attached nutrient cap may rotate, either by a separate electric motor or under the force of the pump that supplies the irrigation fluid.

It will be understood that specific embodiments may include a variety of features in different combinations, as desired by different users. In view of the foregoing, it will be appreciated that the present invention provides a cost-effective improvements to vertical aquaponics systems. The specific techniques and structures for implementing particular embodiments of the invention and accomplishing the associated advantages will become apparent from the following detailed description of the embodiments and the appended drawings and claims.

### BRIEF DESCRIPTION OF THE DRAWINGS

FIGS. 1A-1E illustrate a vertical growing system described in the prior art publication U.S. Pub. No. 20160135398.

FIG. 2A is a perspective bottom view of a nutrient cap for a vertical growing assembly in accordance with an embodiment of the invention.

FIG. 2B is a perspective top view of the nutrient cap of FIG. 2A.

FIG. 2C is a conceptual side view of a first alternative nutrient cap.

FIG. 2D is a conceptual side view of a second alternative nutrient cap.

FIG. 3A is a perspective bottom view of a base for a vertical growing assembly using nutrient caps.

FIG. 3B is a perspective top view of the base of FIG. 3A.

FIG. 3C is a conceptual side view of a first alternative base.

FIG. 3D is a conceptual side view of a second alternative base.

FIGS. 4A-4D illustrate the installation of a vertical growing assembly into a nutrient cap and base assembly.

FIG. 5A is a conceptual illustration of a charged filter cap including a nutrient cap filled with nutrient materials.

FIG. 5B is a conceptual illustration of two vertical growing system connected to a reservoir and a nutrient feed system.

FIG. 6 is a conceptual illustration of multiple-tower vertical growing system connected to a nutrient feed and drain system.

FIG. 7 is a conceptual top view of a four-tower vertical growing system.

FIG. 8 is a perspective view of the bottom portion of a nutrient cap vertical growing system.

FIG. 9 is another perspective view of the bottom portion of the nutrient cap vertical growing system.

FIG. 10 is a perspective view of the top portion of a nutrient cap vertical growing system.

FIG. 11 is another perspective view of the top portion of the nutrient cap vertical growing system.

FIG. 12 is a perspective view of a frame an example nutrient cap vertical growing system.

FIG. 13 is a conceptual illustration of drum type vertical growing system.

FIGS. 14A and 14B are conceptual illustrations of nutrient caps for the drum type vertical growing system.

FIG. 15 is a conceptual cut away view of a drum type vertical growing system.

### DETAILED DESCRIPTION WITH REFERENCE TO THE FIGURES

This application also describes an improvement over the invention described in U.S. patent application Ser. No. 14/943,329 (U.S. Pub. No. 20160135398), which is incorporated by reference. In general, hydroponic systems use man-made chemicals (usually liquids) to nourish the plants. Sometimes, minerals or other substances are also added that can change the pH of the nutrient water Aquaponics systems, on the other hand, use microbiology to convert fish waste to the proper form for the plants to take up. In fact, aquaponics systems may not require any chemicals to augment the fish waste used as nutrients for the plants. The only “manufactured” addition may be actively aerated compost tea made on site which adds more microbiology to the system. In general, hydroponics and aquaponics can't be mixed very well. Aquaponics thus minimizes the use of man-made chemicals, which can kill the fish.

The present invention includes dual aspects, a nutritional component to provide better nutrition to the plants growing in the aquaponics system, and structural components for more conveniently and cost effectively supporting the vertical aquaponic grow towers. The new nutrient caps and bases are a refinement that makes it easy for anyone to grow with aquaponics without the need for any hydroponic chemicals, and with only a few small fish in their reservoir.

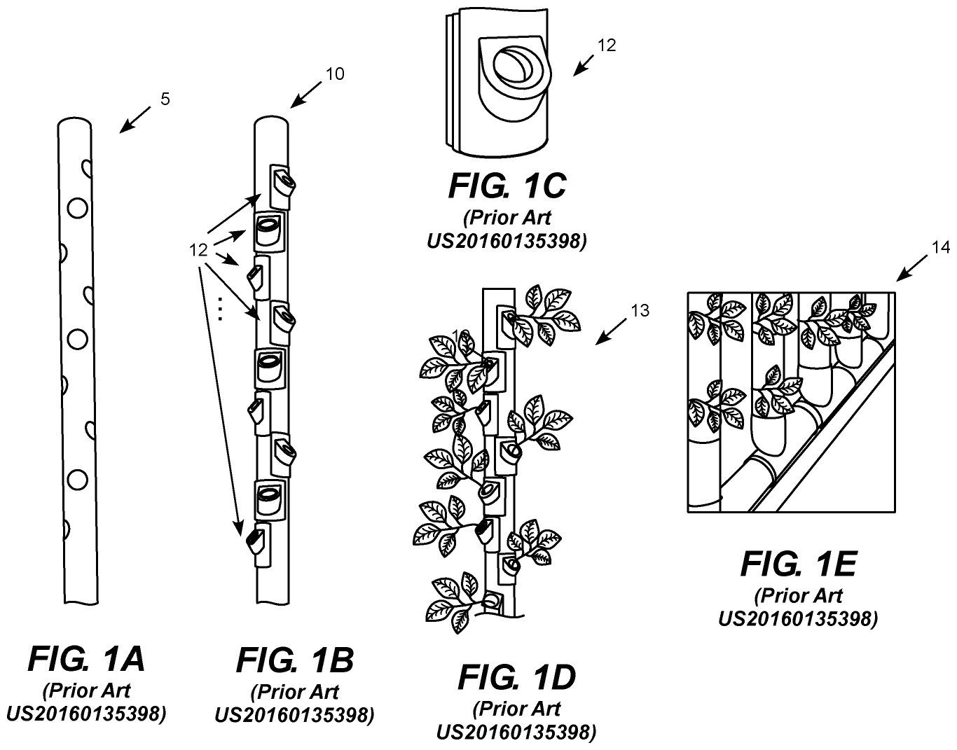

FIGS. 1A-1E illustrate the vertical growing system described in U.S. Pub. No. 20160135398). In one of the embodiments described in this reference, a pipe 5, such as a 4″ PVC pipe, has holes over which “grow pocket” are adhered. The grow pockets receive net cups that hold plants to create an aquaponic plant growing tower. FIG. 1A shows an embodiment utilizing a 4″ PVC pipe, such as a schedule 40 pipe or the thinner ASTM D 2729 pipe. Two inch holes are drilled at intervals using a pattern in which the holes are 6″ apart vertically.

FIG. 1B shows a vertical growing system 10 (also referred to as a “grow tower”) which includes the PVC pipe 5 with grow pockets 12 adhered over the holes adding the “Grow Pockets” (also called “GroPockets”) to the pipe. FIG. 1C shows grow pocket 12, which includes PVC foam shaped and trimmed into the grow pocket shape. The flanges of the grow pocket 12 match the curvature of the 4″ PVC pipe 5. FIG. 1D shows a living vertical growing system 13, in which the grow pockets 12 of the vertical growing system 10 are filled with growing plants. FIG. 1E shows an illustrative system 14 to collecting water at the bottom of the grow towers. A standard tee is fitted to the bottom of the tower pip 10 and incorporated into a 4″ drain pipe laying underneath the row of towers. The sealed off drain system keeps the sun from growing algae in the nutrient-rich drain water.

The grow pockets 12 are formed from PVC, which are glued to the outside of the pipe 5 over each hole using PVC cement so that the roots of the plants fall down into the holes drilled in the PVC pipe 5, as shown in FIG. 1A. Irrigation fluid, which may contain dissolved nutrients, is evenly distributed onto the walls of the pipe 5 from the top of the pipe and hits the roots of all the plants. Prior to the innovation described in U.S. Pub. No. 20160135398, hydration was usually accomplished with plumbing to a lawn sprinkler head.

According to U.S. Pub. No. 20160135398, there is no gravel, clay balls, expanded shale, or other media in the grow tower 10. Consequently, the grow tower 10 is a very aerobic environment. The grow pockets are configured to receive 2″ net pots, which typically include germinating plants when initially inserted into the grow pockets. Net pots are frequently used to start the seedlings elsewhere, which are then transplant to the grow pockets 12 once than have germinated adequately. Typically, the plants germinate in soil or similar growing media while in the net pots. The grow pockets 12 allows the net pot intact with the plant growing in the soil or similar growing media to be inserted into the grow tower 10. The roots of the plant then grow further into the grow tower 10, where the roots receive hydroponic nutrition from nutrient solution flowing downward along the interion surface of the pipe 5.

The GroPocket towers 10 work well but raise some challenges and opportunities for further improvement. Fish waste solids must be dealt with before the water gets to the sprinkler head. Otherwise, the sprinklers get clogged. It takes quite a bit of system pressure to keep the sprinkler heads turning. They tend to stall out when the pressure is too low. Since they are hidden down in the tower, the grower may not aware of the issue until the plants start looking bad. Setting up the drain pipe can also be complicated by the need for a slant from horizontal in order for the water to drain into its destination tank (e.g., aquaponics reservoir). Using traditional plumbing tees at the bottom develop a biofilm which works like a glue to prevent easy removal of the pipe. There is, therefore, a need for an easier way to separate the tower pipes from the drain pipe or reservoir supporting the tower pipes.

An example of a vertical growing system in accordance with the present invent includes a frame with upper frame members and lower frame members, an irrigation fluid supply, and a reservoir or irrigation fluid return system. A grow tower includes a pipe extending between an upper aperture and a lower aperture carries one or more grow pockets attached an outside surface of the pipe. The grow pocket is configured to support living plants with roots extending into the pipe. A cap attached to the upper frame members removable engages with the upper aperture of the pipe. The cap communicates an irrigation fluid received from the irrigation fluid supply into the pipe. A base support by the lower frame members or other support component removably engages with the lower aperture of the pipe. The base communicates the irrigation fluid from the pipe to the reservoir or irrigation fluid return system. The cap and base are positioned for installing the grow tower for upright support between the cap and base, and removing the grow tower from upright support between the cap and base, without detaching the cap from the upper frame members or detaching the base from the lower frame members or other support component.

The cap typically includes a flange and a cup extending from the flange sized to removably fit into an upper portion of the pipe. The cap may also have a dome shaped bottom and openings positioned around a perimeter of the cup to direct the irrigation fluid received from the irrigation fluid supply through the openings and into the pipe onto or adjacent to an inner surface of the pipe. The cap typically houses one or more nutrient media positioned to direct the irrigation fluid from the irrigation fluid supply, through the nutrient media, and into the pipe. A cap containing nutrient media is referred to as a “nutrient cap.” For example, the nutrient media include biochar, which becomes charged by the irrigation fluid (e.g. aquaponics water). Coarse sand or a screen may be used to prevent the biochar from escaping the cap.

The base typically includes a cup sized to removably fit around a bottom portion of the pipe, and a drain hole for draining the irrigation fluid from the pipe. The base may include a flange for attachment to the lower frame members, or it may include a spout that snugly fits into a receptacle of a reservoir lid or return pipe to support the base. The vertical growing system may also include a grow light positioned to illuminate the grow tower, which may rotate to illuminate the grow tower in light-dark cycles.

An illustrative embodiment of the vertical growing system includes four sets of grow towers, caps, and bases, a common frame supporting the caps, a common reservoir supporting the bases. Aquaponics irrigation fluid contained in the reservoir is circulated by a submersible pump in the reservoir, which pumps the irrigation fluid to the caps. A rotating grow light is positioned to illuminate the grow towers in light-dark cycles.

Another illustrative embodiment of the vertical growing system includes a much larger drum carrying a much larger number of grow pockets housing living plants with roots growing into the drum. A nutrient cap housing one or more nutrient media is positioned above the drum. A reservoir positioned below the drum contains an irrigation fluid and a submersible pimp. A conduit for communicates the irrigation fluid from the reservoir into the nutrient cap resulting in the irrigation fluid flowing from the conduit, through the nutrient media, into the drum, and onto the roots of the living plant in the grow pockets. The system may also include one or more grow lights positioned adjacent to the drum to illuminate the plants in the grow pockets and an electric motor or output of the conduit causing the drum to rotate adjacent to the grow lights to illuminate the plants in the grow pockets in light-dark cycles.

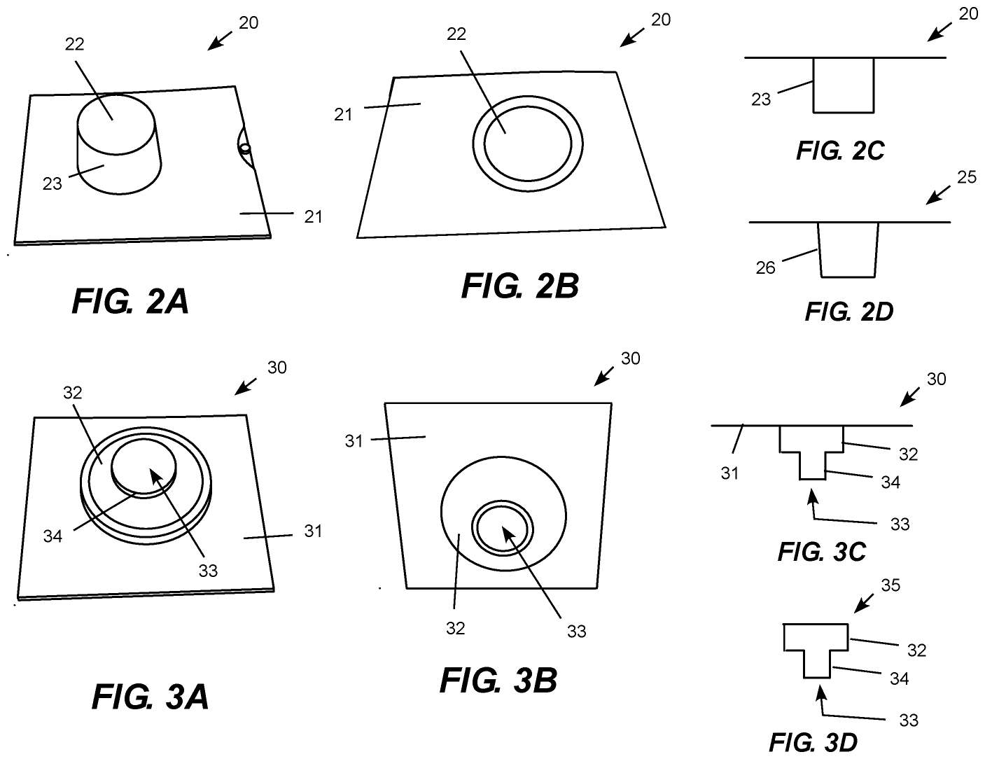

FIG. 2A is a perspective bottom view of a nutrient cap 20 for the vertical growing assembly (tower pipe) 10. The cap 20 includes a flange 21 and a cup 22 which fits into (inside) the top end of the tower pipe 5. This particular cup shown in the figure is configured to fit down inside a 4″ PVC pipe. The bottom surface of the cup 22 has slits, holes, or a screen to allow the water to drip out and into the inside of the tower pipe 10, where it falls onto and past the roots of all the plants in the tower. The cup 22 may have a concave bottom curving upward to insure the water flows to the outside, ant out of the cup, along the edge of the cup.

FIG. 2B is a perspective top view of the nutrient cap 20. Each cap 20 has a flange 21 configured to rest on supports incorporated into a frame supporting the vertical growing towers 10. The flange 21 includes holes providing convenient locations for securing the cap 20 to a frame, such as a pipe or wood frame. Nylon cable ties, bolts, screws or other suitable connectors may be used to secure the flange of the cap 20 to the frame. For example, if the frame is wooden or aluminum, the flange may be attached to the frame with screws through provided screw holes. Attaching the flange 21 of the cap 20 and the base 30 (described below) to the frame allows the cap and base to provide the required support for the tower 10, thus eliminating the need for other types of connectors to support the towers. FIG. 2C shows the first alternative nutrient cap 20 and FIG. 2D shows a second alternative nutrient cap 25. The alternative nutrient cap 20 includes straight (vertical) side wall 23, while the second alternative nutrient cap 25 includes a tapered s side wall 26 to facilitate tilting an sliding the pipe of the grow tower over the cap.

FIG. 3A is a bottom view of the base 30, which fits onto (around the outside) the bottom end of the tower pipe 10. The base 30 a cup 32 configured to fit onto the tower pipe 10. The base 30 also includes a drain hole 33. Depending on the structure that the base drains into, the base 30 may or may not include a spout 34 around the drain hole. The base 30 is similar to a funnel taking the water flowing downward along the inside of the tower pipe 10 and letting it drain through the base into a reservoir or collection pipe at the bottom of the towers. FIG. 3C shows a first alternative of the of the base 30 that includes a flange 31 configured to attach to a frame to support the tower pipe 10. FIG. 3D is a conceptual side view of a second alternative base 35 that does not include a flange. This option is suitable when the spout 34 fits snugly into a reservoir lid or return pipe to securely support the base.

The drain hole 33 should be sufficiently large to prevent roots from clogging the drain. In the embodiment shown with a 4″ tower pipe, for example, 2″ drain holes 33 have been found to be sufficient. Drain holes in the range of 2″ to 2.5″ are suitable for “quick release” connection to appropriately sized holes in a 4″ drain pipe or reservoir cover. Open drilled holes or 2″ tees may be used to attach the base 30 to the drain pipe or reservoir cover. Both approaches reduce the overall expense of using a 4″ connections between the tower pipe 10 and the drain pipe or reservoir cover. In these location, 4″ connections are relatively expensive and not required to support the amount of water circulating through the system.

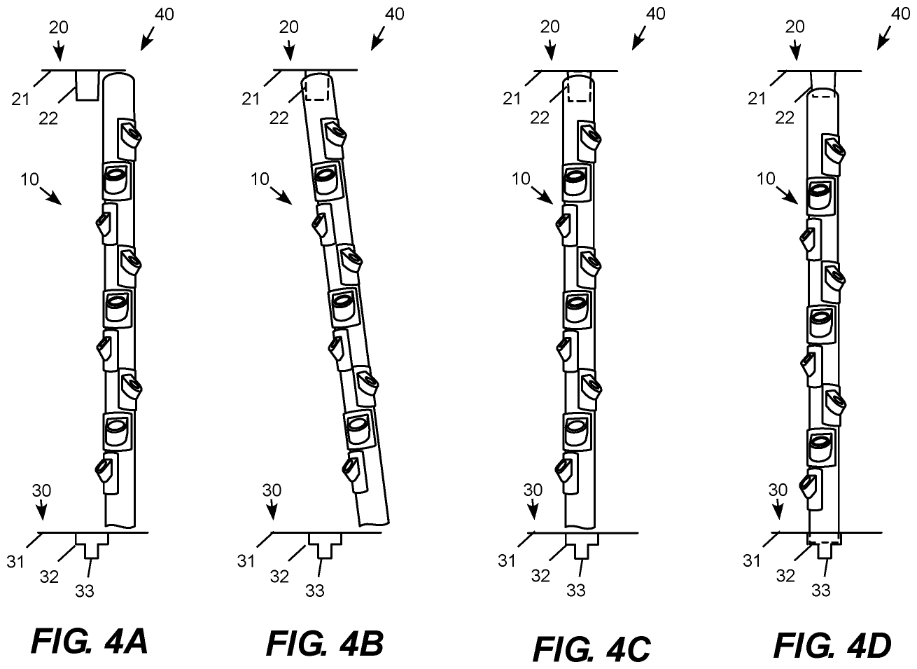

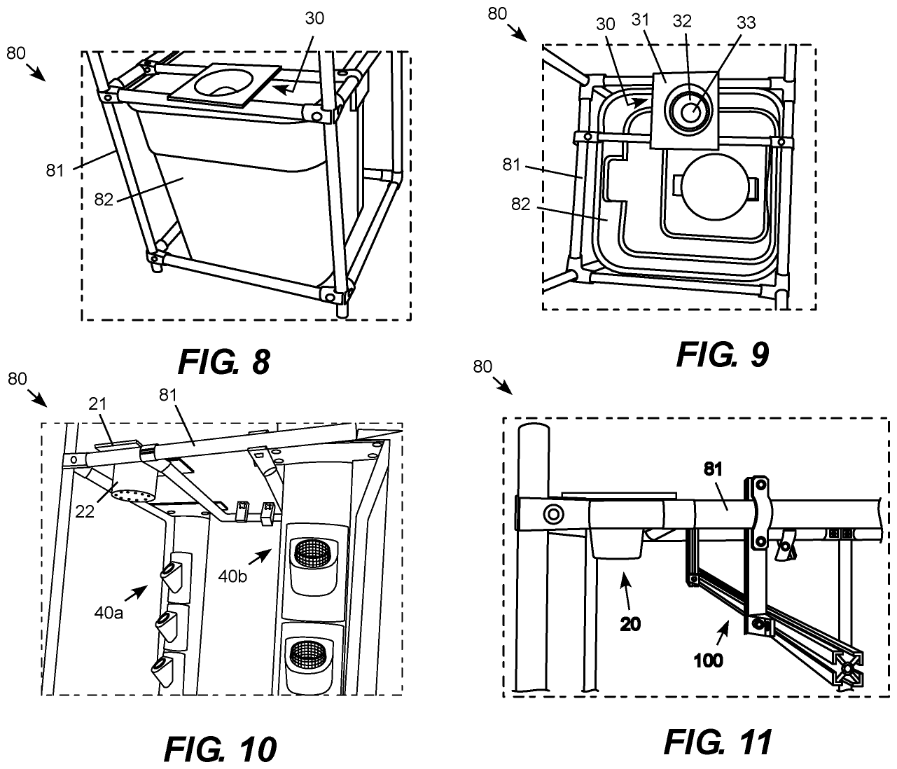

FIGS. 4A-4D illustrate the installation of a vertical growing assembly (tower pipe) 10 into a nutrient cap 20 and base 30 assembly. The nutrient cap 20 and base 30 are attached to a supporting frame and, therefore, remain in place while the tower pipe 10 can be easily moved into and out of engagement with the nutrient cap 20 and base 30 without detaching or removing the nutrient cap or the base from the frame. Although a specific frame is not shown in FIGS. 4A-4D, it will be understood that the nutrient cap 20 and base 30 are in fixed positions for the purpose of these figures, and that illustrative frame arrangements are shown in FIGS. 8-12.

As shown in FIG. 4A, the nutrient cap 20 has a cup 22 that is somewhat longer than the cup 32 of the base 30. In addition, the cup 22 of the nutrient cap 20 fits inside the tower pipe 10, while the cup 32 of the base 30 fits around the outside of the tower pipe. This allows a user to easily install and remove the tower pipe 10 from engagement between the nutrient cap 20 or the base 30 without detaching or removing the nutrient cap or the base from the frame. Specifically, as shown in FIG. 4B, the user tilts the tower pipe 10 slightly and slides the top of the tower pipe over the cup 22 of the nutrient cap 20 until the bottom of the tower pipe clears the base 30. As shown in FIG. 4C, the user then pivots the tower pipe 10 until the bottom of the tower pipe reaches alignment with the cup 32 of the base 30. As shown in FIG. 4D, the user then lowers the tower pipe 10 until the bottom of the tower pipe is fully received into the cup 32 of the base 30. Because the cup 22 of the cap 20 is somewhat longer than the cup 32 of the base 30. This leaves the tower pipe 10 captured between the cup 22 of the cap 20 and the cup 32 of the base 30. In this position, the tower pipe 10 is positioned to communicate a fluid, such as water or nutrient fluid, under the force of gravity, from a fluid supply to the cap 20 to the drain port in the base 30.

In a particular embodiment, the tower pipe 10 is constructed from a 4″ PVC pipe 5 with a number of 2″ holes drilled into the pipe. Grow pockets 12 have been adhered by gluing the flange 21 of the grow pocket to the outside surface of the 4″ PVC pipe 5 over the holes drilled in the pipe. Each grow pockets 12 is formed from a section of PVC foam sheet (e.g., 3/16″ thick) shaped to form the pocket and contour the flange 21 to match the contour of the outer surface of the pipe 5. The cap 20 and base 30 are also formed from sections of PVC foam sheet, typically somewhat thicker (e.g., ⅛″ thick) than the PVC foam sheet used to make the grow pockets 12. As another cost effective alternative, the grow pockets 12, the nutrient caps 20, and the bases 30 may be 3D printed. The cap 20 also includes a flange 21, while the base 30 includes a similar flange 31. The cap flange 21 and the base flange 31 are both attached to respective frame components, for example with cable ties. The cap 20 has a hole to accept suitable irrigation tubing (e.g., ¼″ irrigation tubing), which supplies the irrigation fluid (e.g., plain water, aquaponic water, or other nutrient solution) running through the cap. The irrigation tubing may also be fed from above or below through the concave bottom of the cap. Using tubing for irrigation instead of sprinkler heads eliminates issues of fish waste or other organic solids clogging the sprinkler heads. The cup 22 has a dome-shaped bottom that arches upward to direct the irrigation fluid toward the outside of the cup. Perforations or slits around the perimeter of the cup 22 direct the irrigation water to flow downward under the force of gravity along the inside surface of the pipe 5. Although straight cups 20 have been found to be workable within acceptable tolerances for the 4″ PVC pipe embodiment, the cup 22 may also taper inward as it extends from the flange 21 to facilitate tilting the pipe 5 and sliding it over and removing it from the cup. The base 30 has a drain hole 33 that directs the irrigation fluid into a reservoir or return system.

FIGS. 4A-4D show the combination of the cap 20 and the base 30 that removably capture and support the grow tower 10. This approach avoids the need for hanging the towers with string or other materials. The problem with hanging the towers is that they require a ladder to reach the top and undo the suspension system, which is labor intensive. The cap-and-base design is a significant maintenance improvement because it allows the grower to easily lift the tower pipe up and out of the base, have it clear the base pan and drop out of the cap above. This effectively allows the towers to have extended height without the need for the grower to physically access the top of the tower to remove the tower pipe. For example, 10 ft tower can be easily utilized, since the entire tower can be quickly removed from the bottom of the tower pipe. This allows the tower pipe to be removed from ground level, where it can be tilted or laid down horizontally for harvesting and replanting—without requiring the grower to stand on a ladder or use other elevation or cable techniques used in other plant growing systems, which adds significant complication and expense to grow towers using a suspension system. The improved tower growing system can utilize tall towers that can be accessed without lifting or cable equipment and with no sprinkler heads to maintain, optimizing the utilization of precious floor space either indoors or outdoors.

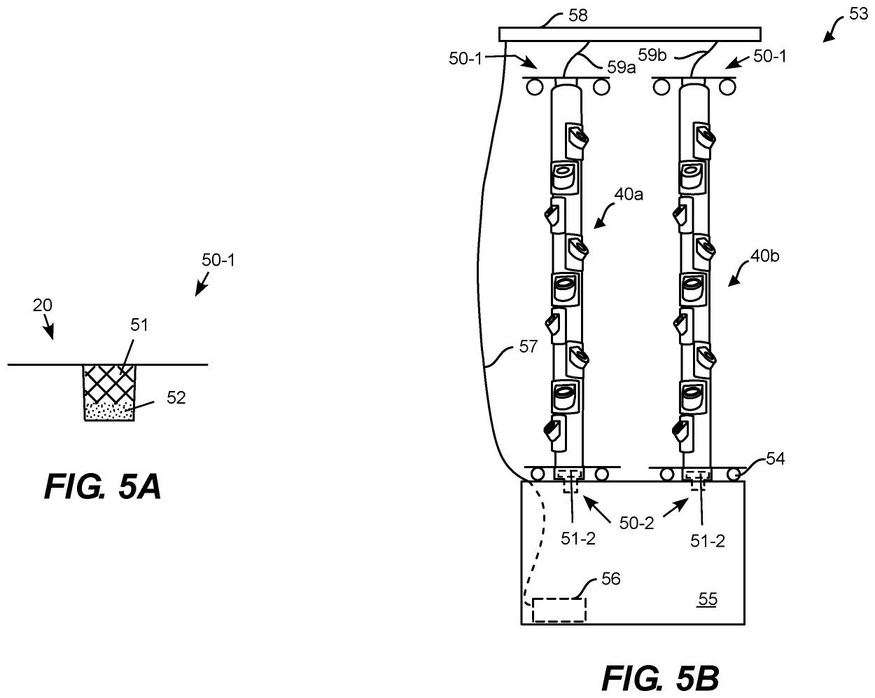

FIG. 5A is a conceptual illustration of a biofilter cap 50-1 including a nutrient cap 20 filled with nutrient materials. In this particular example, the nutrient materials inside the cap 20 include a layer of biochar 51 above a layer of basaltic sand 52. The biochar 51, which may include a source of micro-nutrients mixed in, provides an excellent growing environment for microbes received from the aquaponics water or other microbe source. Introducing microbes into biochar, where the microbes can flourish, may be referred to as “charging” the biochar. Maintaining aquaponics water flowing through the biochar keeps the living microbiology growing on all the cellular surfaces of the biochar, where the aquaponic nutrients feed the microbiology growing in the biochar biofilter cap 50-1. One purpose of the microbiology in such systems is to chelate the minerals so that they are available to the plants. The microbiology also processes the ammonia produced by the fish in the aquaponics reservoir into nitrates which are available to the plants. Additionally or alternatively, the system may include one or more biofilter bases 50-2, similar to the biofilter cap 50-1, that include one or more nutrient media. For example, a filter pouch 51-2 containing a nutrient or other material may be positioned in the base to create the biofilter base 50-2.

The biofilter cap 50-1 is designed to house a multiple layers of media for cultivating microbiology inside the cap and providing nutrients to the plants growing in the towers. In this particular embodiment, basalt sand 52 form the bottom layer of the media inside the biofilter cap. The sand 52 keeps the water flowing correctly through the slits, holes or screen in the bottom of the cap 20. The sand 52 helps to ensure even dispersal of the irrigation fluid via natural wicking action. The sand 52 may be sufficiently coarse, or an additional screen may be used, to prevent sand loss that could occur from sand from passing through the bottom of the cap into the tower pipe. The next layer 51 may be biochar optionally mixed with a source of solid micro-nutrients, such as lakebed sediment, clay or another source of desirable micro-nutrients. Biochar is an excellent choice for the filter material inside the nutrient cap because it is lighter that the basaltic sand and has something on the order of 500-1500 times more surface area than sand. This keeps the weight of the caps down while also facilitating large microbiology colonies, sometimes referred to as “biofilters.” Solid fertilizer, egg shells, perlite, vermiculite, potash, coco coir, small wood chips, and other materials may be mixed in or applied as additional layers, as desired, to provide the desired flow rate and nutrients. The irrigation fluid flowing through the layers gradually dissolves the solid micro-nutrients, which feeds the plants.

FIG. 5B shows a two-tower growing system 53 including grow towers 10a, 10b supported from above by biofilter caps 50a, 50b, respectively. The grow towers 10a, 10b are supported from below by bases 30a, 30b, respectively. The biofilter caps 50a, 50b and bases are 30a, 30b are each attached to frame components (only one frame component 54 is labels to avoid cluttering the figure), for example with cable ties. The bases are 30a, 30b are positioned above a reservoir 55 containing a submersible pump 56 that feeds the irrigation fluid from the reservoir through a supply pipe 57 (e.g., ½″ tubing) into a manifold 58 positioned above the biofilter caps 50a, 50b. Supply tubes 59a, 59b feed the irrigation fluid from the manifold 58 to the biofilter caps 50a, 50b, where the irrigation fluid flows through the materials in the biofilter caps, along the dome-shaped bottom of the cups of the biofilter caps toward the edges of the cups, through perforations or slits around the perimeters of the cups, along the inside surfaces of the grow towers 10a, 10b to feed the roots of the plants that extend into the towers, out the drain holes in the base 30a, 30b, and into the reservoir 55. Gravity feeds the nutrient fluid from the manifold 58 to the reservoir 55, where the pump 56 recirculates the nutrient fluid.

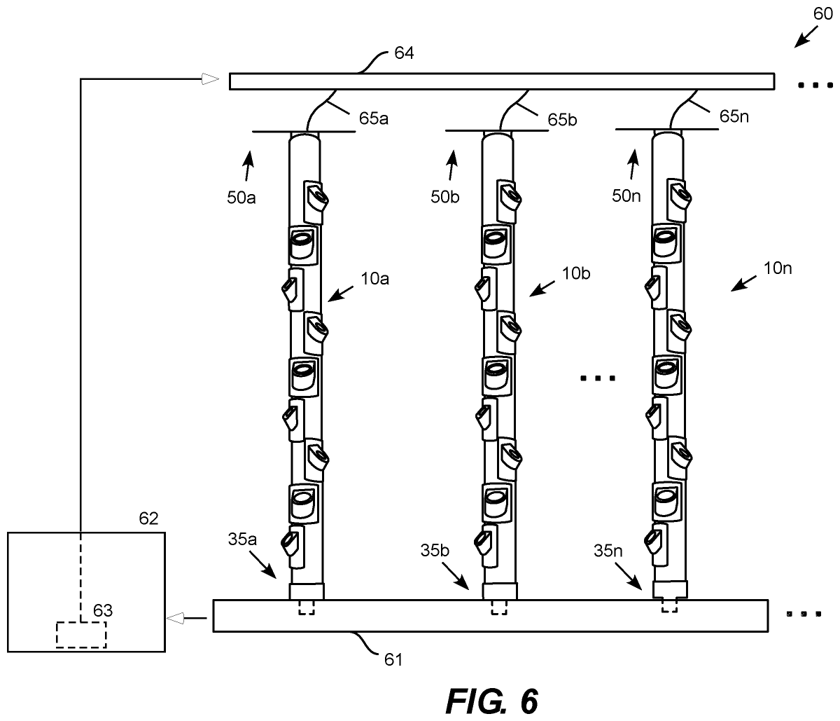

FIG. 6 is a conceptual illustration of growing system 60 for a larger number of towers including grow towers 10a-n supported from above by biofilter caps 50a-n, respectively. The grow towers 10a-n are supported from below by bases 30a-n, respectively. The biofilter caps 50a-n and bases are 30a-n are each attached to frame components (not shown to avoid cluttering the figure), for example with cable ties. The bases 30a-n are positioned above a return manifold 61 that returns the irrigation fluid to an irrigation supply 62, such as a pond or tank. A submersible pump 63 feeds the irrigation fluid from the irrigation supply 62 through a supply manifold 64 positioned above the biofilter caps 50a-n. Supply tubes 65a-n feed the irrigation fluid from the manifold 64 to the biofilter caps 50a-n, where the irrigation fluid flows through the materials in the biofilter caps, along the dome-shaped bottom of the cups of the biofilter caps toward the edges of the cups, through perforations or slits around the perimeters of the cups, along the inside surfaces of the grow towers 10a-n to feed the roots of the plants that extend into the towers, out the drain holes in the base 30a-n, and into the return manifold 61. Gravity feeds the nutrient fluid from the supply manifold 61 to the irrigation supply 62, where the pump 63 recirculates the nutrient fluid.

In this particular embodiment, the manifolds 61 and 64 may be irrigation pipe or tubing (e.g., ½″ irrigation tubing). The supply tubes 65a-n may be attached to the supply manifold 64 with self-piercing barb emitters inserted. Each barb emitter is designed to pierce the larger ½″ tubing and make a connection to ¼″ tubing. The water drips down the tower, keeping the roots of all the plants moist, and out the drain holes in the bases 30a-n into the return manifold 61 (drain pipe). In a typical arrangement, holes drilled in the manifold 61 (drain pipe) are sized to receive the drain spouts of the base 30a-n.

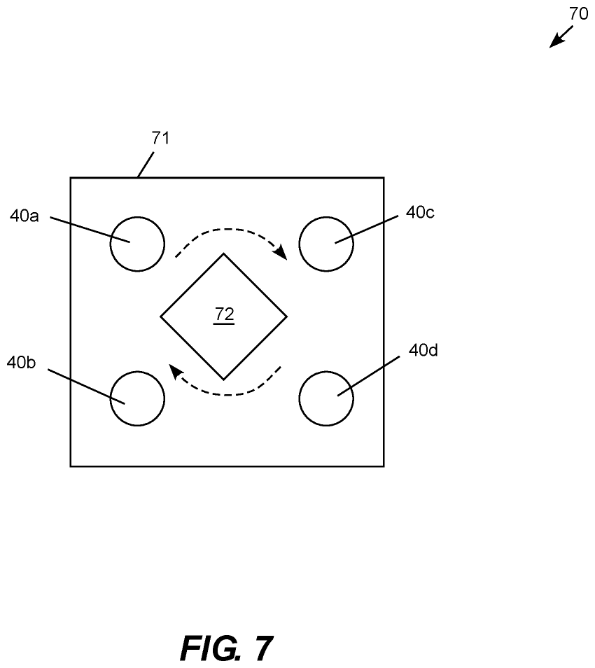

FIG. 7 is a conceptual top view of a four-tower vertical growing system 70 as seen from above. The system includes four grow towers 40a-d above a reservoir 71 with an submersible pump. similar to the arrange shown in FIG. 5B, with four grow towers in a square pattern instead of two as shown in FIG. 5. This particular embodiment includes a grow light stand 72 in the center of the grow towers 40a-d, which is typically about the same height as the grow towers 40a-d. The grow light stand 72 may include lights on all sides or fewer sides, for example there may be lights on only one or two sides. When there are lights on only one or two sides, an electric motor or other suitable device may rotate the grow light stand 72 on a daily schedule to simulate natural light-dark cycles. The rate of rotation may typically be selected by the user. Too much light to fast causes tip burn and improper growing. To prevent tip burn, the light level must be either lower, or the light removed form plant periodically. Applying a light-dark cycle reduces plant stress from too much light too fast to avoid tip burn without reducing the intensity of the light. Rather than place the light a long distance away from the plant, the light can best be maximized by placing it very close to the plant (within a few inches) but removing the light from the plant periodically so that the plant has time to fully process the photosynthetic activity. In a particular embodiment, the grow light stand 72 hanging down from a frame in the middle of the towers. In this example, LED strips are attached to one or more sides of a long piece of aluminum extrusion, which radiates light to plants all the way down the grow tower. To take advantage of the light, the plants face inward toward the light stand 72.

The extrusion, which may include an integrated mounting bracket, also serves as a heat sink for the lights. In addition, the light stand may be supported by a trolley that allows the light to be move for service of the reservoir. It also allows the light to be adjusted between the towers depending on size of the plants in each tower. For example, the lights might be closer to the towers on one end where the plants are less mature and smaller. Also plant growth is much better if the light source is moved around a bit. This avoids leaf shadowing, where the plants' own leaves block access to light. This light trolley can be motorized to move back and forth between 8 towers. If lighting is done in 12 hour shifts, a single light trolley can provide light for up to 16 towers. While the general concept of light movers is not new, the present embodiment combines moving lights with vertical grow towers to accomplish the advantages of preventing leaf shadowing and mimicking the sun.

Vertical tubes and vertical lighting also facilitate improved air flow as compared to the stacked shelves of horizontal growing systems. The heat naturally moves up and is not trapped by the shelf above. Adequate air circulation is a major issue in growing. Without it, plants don't have enough CO2 and tend to develop more mold and other diseases.

FIG. 8 is a perspective side view the lower portion of an illustrative embodiment of a nutrient cap vertical growing system 80 including a frame 81, reservoir 82, and base 30. In this particular example, the frame 81 is made from 1-inch steel tubing and the reservoir 82 is a standard square plastic tub with a capacity of 32 gallons of water resting on the ground or floor below the tub. Cross pieces of the frame 81 support the base 30, which is typically attached to the frame with cable ties. FIG. 9 shows the vertical growing system 80 from overhead. This view shows also shows the flange 31, cup 32, and spout (drain) 33 of the base 30.

FIG. 10 shows the upper portion of the vertical growing system 80 including the frame 81 supporting a cap 21, which is which is typically attached to the frame with cable ties. This view shows the flange 21 and the cup 22 of the cap 20. Two grow towers 40a and 40b are also shown in FIG. 10. FIG. 11 is another view of the top of the vertical growing system 80. The frame 81, cap 20 and a lighting support 100 are visible in this view.

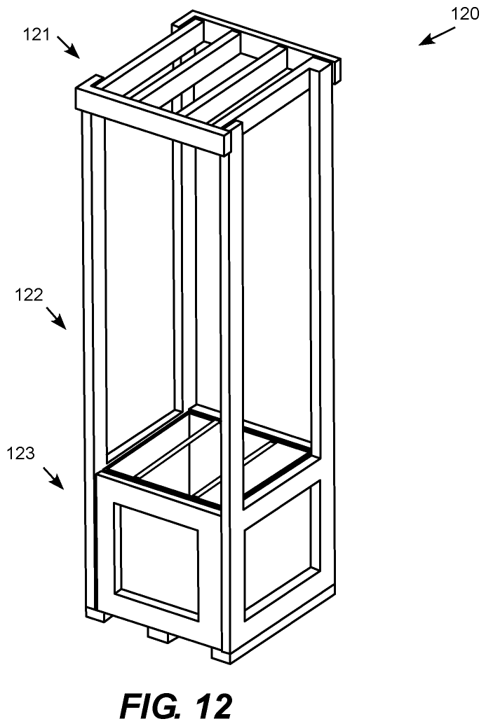

FIG. 12 shows a decorative typically wood or plastic “grow stand” 120 alternative to the steel tubing structure, which provides a more visually attractive option suitable to in-home and in-store setting. The grow stand 120 includes an upper trellis 121 with horizontal slats to support caps for the grow towers. The grow stand 120 also includes upright supports 122 connecting the upper trellis 121 with a lower basket 123 topped with removable horizontal slats to support bases for the grow towers. The lower basket 123 is sized to hold a reservoir, such as a 32 gallon tub. Alternatively, the lower basket 123 itself may serve as the water tight reservoir. The grow stand 120 is sized to hold a 4-tower growing system with a central light, as shown in FIG. 7. Another lighting alternative is using the upper trellis 121 as a track supporting overhead LED grow lights.

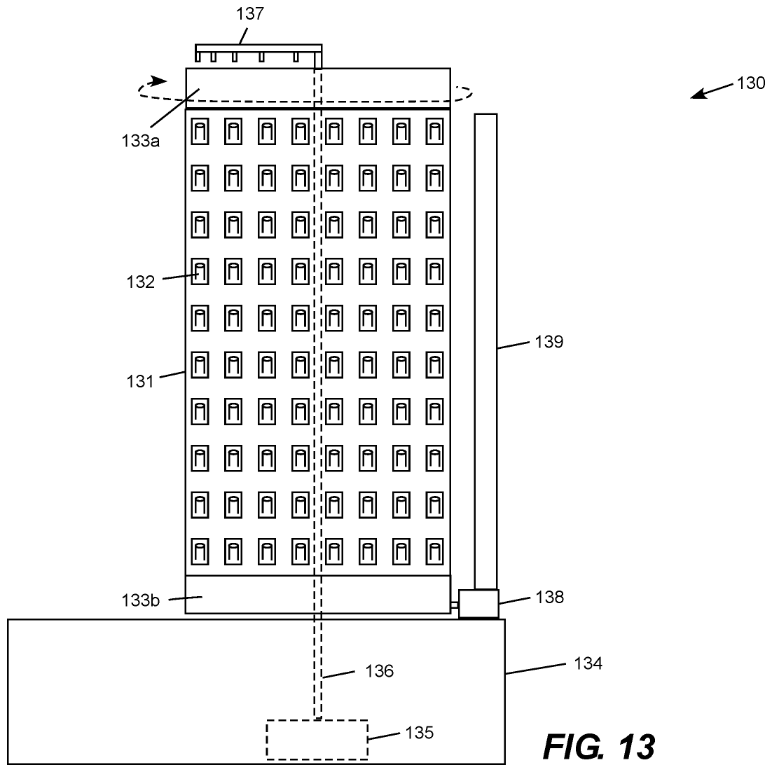

FIG. 13 is a conceptual illustration of drum type vertical growing system 130. Compared to the vertical pipe type grows towers, the drum type system includes a much larger drum 131 housing a much larger number of grow pockets 132 (only one grow pocket is labeled to avoid cluttering the figure) with a much larger nutrient cap 133a and a much larger reservoir 134. A submersible pump 135 in the reservoir 134 communicates irrigation fluid up a conduit 136 to a spray head 137 above the nutrient cap 133. This particular example includes a fixed spray head 137 and an electric motor 138 that rotates the drum 131 with attached nutrient cap 133 under the spray head 137. An electric grow light 139 is positioned adjacent to the drum 131 to illuminate the plants as they pass past the grow light 139. Multiple grow lights may be positioned around the drum 131 to illuminate the plants in the grow pockets 132 in light-dark cycles as the drum rotates. For example, an illustrative embodiment includes a 30-inch diameter drum 131 and nutrient cap 133 carrying 160 grow pockets 132 on a 150 gallon reservoir 134. An example of larger embodiment includes a 55-inch diameter drum 131 and nutrient cap 133 carrying 520 grow pockets on a 360 gallon reservoir. In general, the drum and reservoir are about 9′ tall to allow a person standing on the ground to access the nutrient cap 133. The design can be extended to 7′ tall when the user is expected to stand on a foot stool or short step ladder to access the nutrient cap 133. Embodiments of the drum 131 may have different horizontal cross-sectional shapes, such as round, square, octagonal, and so forth. Additionally or alternatively, the system may include biofilter base 133b, similar to the biofilter cap 133a, that includes one or more nutrient media.

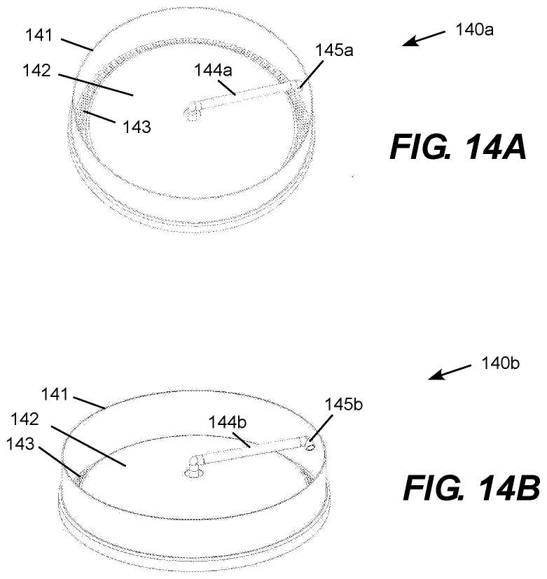

FIGS. 14A and 14B are conceptual illustrations of nutrient caps 140a and 140b, respectively, for the drum type vertical growing system. Both embodiments include a side rim 141 high enough to hold a desired quantity of nutrient media, such as charged biochar and sand, in the cap. In the example, the nutrient caps 140a and 140b have a diameter of 30 inches and the side rim 141 has a height of 5 inches. The bottom 142 of the caps slopes downward form the center toward perforations 143 around the perimeter of the cap. The nutrient cap 140a includes a fixed spray arm 144a with a spray head 145a directed toward the bottom 142 (i.e., vertically downward) of the cap, which is suitable for use with a rotating drum driven by an electric motor. The nutrient cap 140b, on the other hand, includes a rotating spray arm 144b with a spray head 145b directed in alignment with the bottom 142 of the cap (i.e., horizontally). In this configuration, the force of the irrigation fluid expelled from the which causes the spray head 145b causes the spray arm 144b to rotate without requiring an electric motor in addition to the pump driving the irrigation fluid through the spray head. In another embodiment, the force of the irrigation fluid expelled from may cause the entire drum with attached nutrient cap to rotate. Alternatively, the nutrient caps 140a with the downward directed spray head 145a may include arcuate fins around the inside perimeter of the side rim 141. In this alternative, the irrigation fluid is sprayed on the fins, which causes with the nutrient cap 140a or the entire drum with attached nutrient cap to rotate under the force of the irrigation fluid imparted by the pump without requiring an electric motor.

The nutrient caps 140a and 140b, are filled with nutrient media, such as charger biochar and coarse sand. In these embodiments, the coarse sand may be placed over the perforated channels to act as a filter for large particles and provide bio-filtration for organic nutrient breakdown.

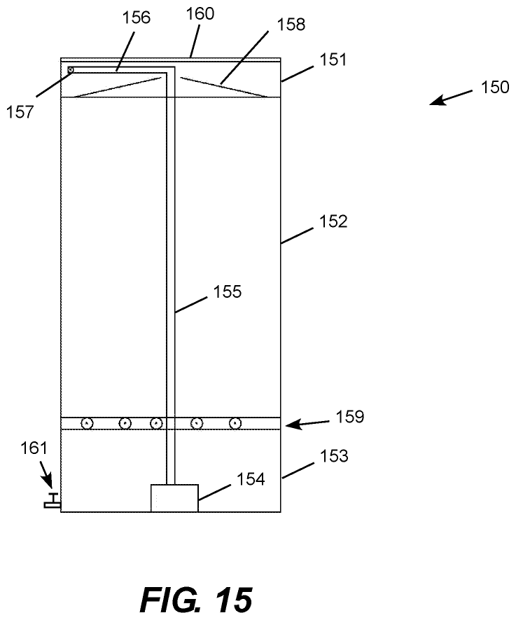

FIG. 15 is a conceptual cut away view of a drum type vertical growing system 150. This view shows a nutrient cap 151 above a drum 152, which sits atop a reservoir 153. A submersible pump 154 in the reservoir 153 communicates irrigation fluid from the reservoir up a conduit 155, through spray arm 156, and out a spray head 157. The sloping bottom 158 of the nutrient cap 151 directs the nutrient fluid from the nutrient cap onto the inner surface of the drum 152, where it moistens the roots of the plants extending from the grow pockets into the drum. In this embodiment, the drum 152 with attached nutrient cap 151 are supported by a bearing assembly 159 that allows the drum and nutrient cap to easily rotate above the reservoir 153. The spray head 157 is pointed laterally (horizontally), which causes the drum 152 with attached nutrient cap 151 to rotate under the force of the irrigation fluid imparted by the pump 154 without requiring an electric motor. This is a desirable arrangement because it can be used to rotate the plants in the grow pockets carried on the outside of the drum 152 past an artificial lighting system or window using only the force imparted by the pump 154.

In an illustrative embodiment, the bearing assembly 159 include twelve one-inch Polyoxymethylene (POM) plastic ball bearings, which are most commonly used in check valves because they are tough, self-lubricating and water proof. The ball bearings sit in a lower race that allows the ball bearings to rotate freely while positioned around the outer perimeter of the reservoir 153. An upper, moving race attached to the bottom of the drum 152 has a mating groove that slides over ball bearings. This allows the relatively heavy drum carrying a large number of growing plants, as well as the attached nutrient cap filled with a nutrient media, to be economically and easily rotated.

The vertical growing system 150 also includes a light shield 160, which shields the roots growing inside the drum 151 from light, which can stunt the root growth. The reservoir 153 includes a valve 161 for adjusting the volume of irrigation fluid or periodic purging the fluid, as necessary. In this embodiment, the irrigation fluid is plumbed from the reservoir 153. In an alternative embodiment, the irrigation fluid may be obtained from a supply line located above the tower. Having the plumbing enter at the center of the nutrient cap allows the drum with attached nutrient cap to rotate without having to rotate the supply line.

The invention claimed is:

1. A vertical growing system, comprising:
a frame comprising upper frame members and lower frame members;
an irrigation fluid supply;
a reservoir or irrigation fluid return system;
a grow tower comprising a pipe extending between an upper aperture and a lower aperture and carrying one or more grow pockets attached an outside surface of the pipe configured to support living plants with roots extending into the pipe;
a cap for attachment to the upper frame members, for removable engagement with the upper aperture of the pipe, and for communicating an irrigation fluid received from the irrigation fluid supply into the pipe;
a base for support by the lower frame members or other support component, for removable engagement with the lower aperture of the pipe, and for communicating the irrigation fluid from the pipe to the reservoir or irrigation fluid return system;
wherein the cap and base are positioned for installing the grow tower for upright support between the cap and base, and removing the grow tower from upright support between the cap and base, without detaching the cap from the upper frame members or detaching the base from the lower frame members or other support component.

2. The vertical growing system of claim 1, wherein the cap further comprises a flange and a cup extending from the flange sized to removably fit into an upper portion of the pipe.

3. The vertical growing system of claim 1, wherein the cap further comprises a dome shaped bottom and openings positioned around a perimeter of the cup to direct the irrigation fluid received from the irrigation fluid supply through the openings and into the pipe onto or adjacent to an inner surface of the pipe.

4. The vertical growing system of claim 1, wherein the cap houses one or more nutrient media positioned to direct the irrigation fluid from the irrigation fluid supply, through the nutrient media, and into the pipe.

5. The vertical growing system of claim 4, wherein the nutrient media further comprises biochar.

6. The vertical growing system of claim 1, wherein the irrigation fluid further comprises aquaponics water.

7. The vertical growing system of claim 1, wherein the base further comprises a cup sized to removably fit around a bottom portion of the pipe, and a drain hole for draining the irrigation fluid from the pipe.

8. The vertical growing system of claim 1, wherein the base further comprises a flange for attachment to the lower frame members, a cup extending from the flange sized to removably fit around a bottom portion of the pipe, and a drain hole for draining the irrigation fluid from the pipe.

9. The vertical growing system of claim 1, wherein the base further comprises a spout around the drain hole sized to fit into a receptacle of a lid of the reservoir.

10. The vertical growing system of claim 1, wherein the base further comprises a spout around the drain hole sized to fit into a receptacle of the irrigation fluid return system.

11. The vertical growing system of claim 1, further comprising a grow light positioned to illuminate the grow tower.

12. The vertical growing system of claim 1, further comprising a rotating grow light positioned to illuminate the grow tower in light-dark cycles.

13. The vertical growing system of claim 1, further comprising:
four sets of the grow towers, the caps, and the bases;
a common frame supporting the caps;
a common reservoir in fluid communication with the bases;
an aquaponics irrigation fluid contained in the reservoir;
a submersible pump in the reservoir for pumping the irrigation fluid to the caps;
a grow light positioned to illuminate the grow towers in light-dark cycles.

14. The vertical growing system of claim 13, wherein:
each cap further comprises a flange and a cup extending from the flange sized to removably fit into an upper portion of a corresponding pipe;
each base further comprises a cup sized to removably fit around a bottom portion of the corresponding pipe, a drain hole for draining the irrigation fluid from the corresponding pipe into the reservoir, and a spout around the drain hole sized to fit into a receptacle in a lid of the reservoir.

15. The vertical growing system of claim 14, wherein each cap further comprises one or more nutrient media positioned to direct the irrigation fluid received from the reservoir through the nutrient media and into the corresponding pipe.

16. The vertical growing system of claim 15, wherein the nutrient media further comprises biochar.

17. The vertical growing system of claim 16, wherein each cap further comprises a dome shaped bottom and openings positioned around a perimeter of the cup to direct the irrigation fluid received from the reservoir through the openings and into the corresponding pipe onto or adjacent to an inner surface of the corresponding pipe.

18. A vertical growing system, comprising:
a drum carrying a plurality of grow pockets housing living plants with roots growing into the drum;
a nutrient cap housing one or more nutrient media positioned above the drum;
a reservoir positioned below the drum containing an irrigation fluid;
a submersible pimp positioned within the reservoir;
a conduit for communicating the irrigation fluid from the reservoir into the nutrient cap;
wherein the irrigation fluid flows from the conduit, through the nutrient media, into the drum, and onto the roots of the living plant in the grow pockets.

19. The vertical growing system of claim 18, further comprising a grow light positioned adjacent to the drum to illuminate the plants in the grow pockets.

20. The vertical growing system of claim 19, further comprising an electric motor or output of the conduit rotating the drum adjacent to the grow light to illuminate the plants in the grow pockets in light-dark cycles.
